(19) United States
(12) Patent Application Publication
(10) Pub. No.: US 2022/0329201 A1
(43) Pub. Date: Oct. 13, 2022

(54) SYSTEMS AND METHODS FOR AUTONOMOUS DRONE-BASED SOLAR PANEL MAINTENANCE

(71) Applicant: Robotic Research OpCo, LLC, Clarksburg, MD (US)

(72) Inventors: Alberto Daniel Lacaze, Potomac, MD (US); Karl Nicholas Murphey, Cocoa Beach, FL (US)

(21) Appl. No.: 17/716,121

(22) Filed: Apr. 8, 2022

Related U.S. Application Data
(60) Provisional application No. 63/172,589, filed on Apr. 8, 2021.

(51) Int. Cl. H02S 20/32; F24S 50/20

(52) U.S. Cl. CPC H02S 20/32; F24S 50/20; F24S 2050/25

(57) ABSTRACT

Systems and methods for autonomous drone-based solar panel maintenance may utilize drone positioning, image analysis, and processing to determine solar panel angle and clarity.

### CROSS-REFERENCE TO RELATED APPLICATIONS

This application claims benefit and priority under 35 U.S.C. § 119(e) to, and is a Non-provisional of, U.S. Provisional Patent Application No. 63/172,589 filed on Apr. 8, 2021 and titled “SYSTEMS AND METHODS FOR DRONE-BASED SOLAR PANEL MAINTENANCE”, which is hereby incorporated by reference herein in its entirety.

### BACKGROUND

As larger solar farms are created around the world, there is a need for maintenance on the solar arrays. Many of these solar panels are motorized (i.e., include active tracking mechanisms; “active”) so that they move and align with the sun. Small misalignments can cause the panels to produce less energy. Also, panels get dirty with dust and other contaminates that can lead to a reduction in efficiency. Therefore, most solar arrays are inspected for misalignment or dirt and occlusions that can diminish their efficacy. Currently, most of these inspections are performed manually with a person going panel to panel to individually contact measure each panel using an inclinometer to measure the accuracy of the alignment and to measure the dirt that may have accumulated on the surface of the panels. Because some of these solar farms are extensive, inspection becomes a laborious task that can take days or weeks to perform.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram of a system according to some embodiments;

FIG. 2A, FIG. 2B, FIG. 2C, and FIG. 2D are block diagrams of a system according to some embodiments;

FIG. 3A, FIG. 3B, FIG. 3C, FIG. 3D, FIG. 3E, and FIG. 3F are block diagrams of a system according to some embodiments;

FIG. 4A and FIG. 4B are block diagrams of a system according to some embodiments;

FIG. 5A and FIG. 5B are block diagrams of a system according to some embodiments;

FIG. 6 is a flow diagram of a method according to some embodiments;

FIG. 7 is a block diagram of an apparatus according to some embodiments; and

FIG. 8A, FIG. 8B, FIG. 8C, FIG. 8D, and FIG. 8E are perspective diagrams of exemplary data storage devices according to some embodiments.

### DETAILED DESCRIPTION

I. Introduction

Solar panels generally have glass or glossy surfaces that reflect some of the light rays from the sun. In embodiments of the present invention, a drone may navigate between the sun and a solar panel and measure the sun's reflection off of the panel. The difference in angle between the reflection and the sun's rays provides a measure of the panel's alignment. In such a manner, the drone may navigate across a large solar array and measure panel alignments in an efficient and accurate manner, reducing labor costs and reducing the amount of time that panels may be unknowingly out of alignment. The brightness of the reflection from the solar panels may also provide a measure of the panel's cleanliness (or level of obfuscation, e.g., by snow or other debris), which may also or alternatively be measured by the inspection drone.

II. Drone-based Solar Panel Maintenance Systems

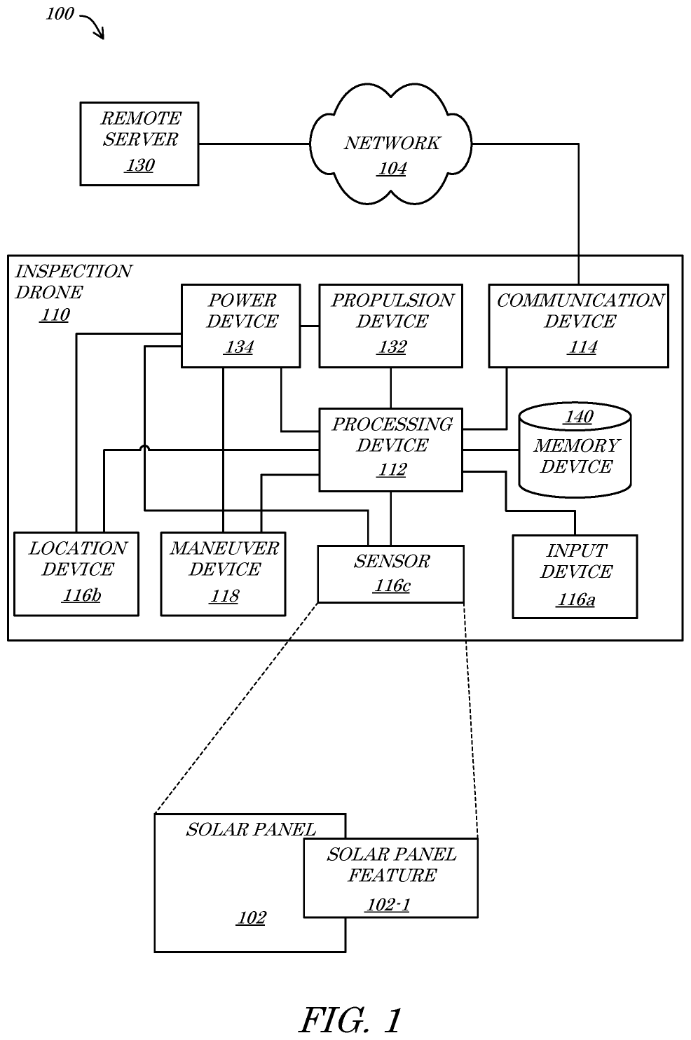

Referring first to FIG. 1, a block diagram of a system 100 according to some embodiments is shown. In some embodiments, the system 100 may comprise a solar array or solar panel 102 (e.g., comprising a solar panel feature 102-1), a network 104, and/or an inspection drone 110. The inspection drone 110 may comprise, for example, a processing device 112, a communication device 114, an input device 116a, a location device 116b, a sensor 116c, and/or a maneuver device 118. In some embodiments, the inspection drone 110 may be in communication with, e.g., via the network 104, a remote server 130. According to some embodiments, the inspection drone 110 may comprise a propulsion device 132, a power device 134, and/or a memory device 140.

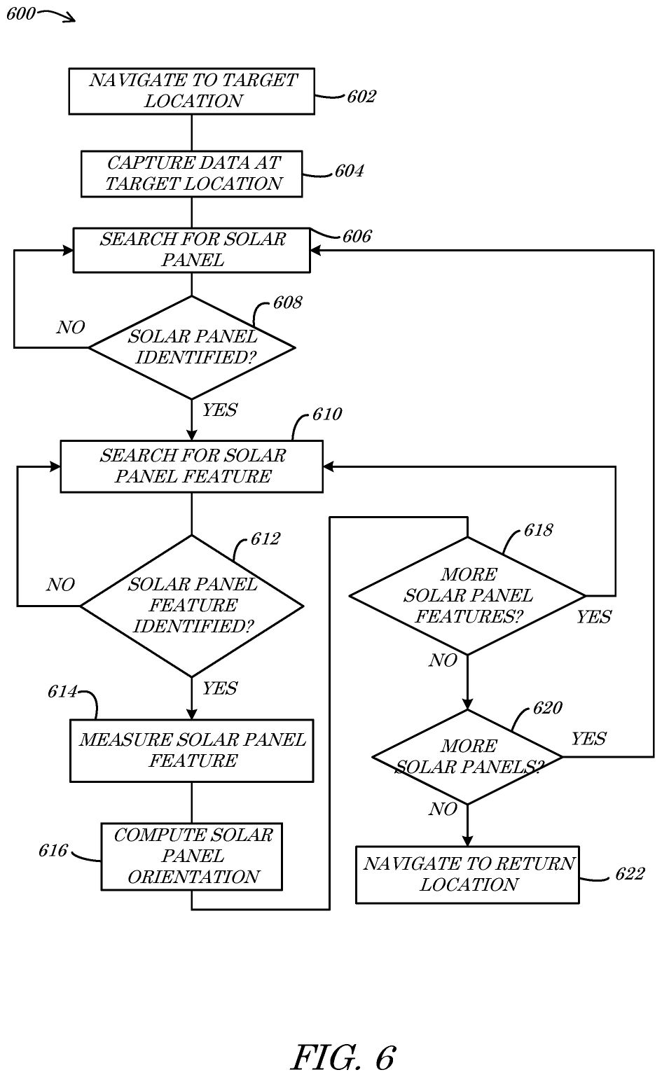

Fewer or more components 102, 102-1, 104, 110, 112, 114,116a-c, 118, 130, 132, 134, 140 and/or various configurations of the depicted components 102, 102-1, 104, 110, 112, 114, 116a-c, 118, 130, 132, 134, 140 may be included in the system 100 without deviating from the scope of embodiments described herein. In some embodiments, the components 102, 102-1, 104, 110, 112, 114, 116a-c, 118, 130, 132, 134, 140 may be similar in configuration and/or functionality to similarly named and/or numbered components as described herein. In some embodiments, the system 100 (and/or portion thereof) may comprise an autonomous solar panel maintenance system and/or platform programmed and/or otherwise configured to execute, conduct, and/or facilitate the method 600 of FIG. 6 herein, and/or portions thereof.

According to some embodiments, the solar panel 102 may comprise any type, configuration, and/or quantity of Photo-Voltaic (PV), thermophotovoltaic, and/or thermal hot water panels that are or become known or desirable. The solar panel 102 may comprise, for example, one or more PV cells, modules, panels, and/or arrays, such as one or more Panasonic® EverVolt™ EVPV360 three-hundred and sixty Watt (360 W) panels. While not shown separately, the solar panel 102 and/or the system 100 may comprise various mounts, brackets, positioning devices, motors, solar tracking devices (active and/or passive), charge controllers, energy converters, cables, wires, switches, etc. in communication with the one or more solar panels 102. According to some embodiments, the solar panel 102 may comprise and/or define one or more of the solar panel features 102-1. In some embodiments, the solar panel feature(s) 102-1 may comprise any distinguishable, measurable, and/or readable element and/or object of the solar panel 102 that may be detected, sensed, measured, and/or read by the inspection drone 110 (and/or the sensor 116c thereof). The solar panel feature(s) 102-1 may comprise, for example, a solar cell boundary, a joint between solar cells and/or panels, an edge of the solar panel 102, a label, logo, or other machine-readable indicia, a reflection, and/or an area exhibiting characteristics that differ from other areas of the solar panel 102 such as brighter, darker, hotter, and/or colder areas.

The network 104 may, according to some embodiments, comprise a Local Area Network (LAN; wireless and/or wired), cellular telephone, Bluetooth®, Near Field Communication (NFC), and/or Radio Frequency (RF) network with communication links between the remote server 130 and the inspection drone 110. In some embodiments, the network 104 may comprise direct communication links between any or all of the components 102, 102-1, 104, 110, 112, 114, 116a-c, 118, 130, 132, 134, 140 of the system 100. The sensor 116b may, for example, be directly interfaced or connected to one or more of the processing device 112 and/or the remote server 130 via one or more wires, cables, wireless links, and/or other network components, such network components (e.g., communication links) comprising portions of the network 104. In some embodiments, the network 104 may comprise one or many other links or network components other than those depicted in FIG. 1. The inspection drone 110 may, for example, be connected to the remote server 130 via various cell towers, routers, repeaters, ports, switches, and/or other network components that comprise the Internet and/or a cellular telephone (and/or Public Switched Telephone Network (PSTN)) network, and which comprise portions of the network 104.

While the network 104 is depicted in FIG. 1 as a single object, the network 104 may comprise any number, type, and/or configuration of networks that is or becomes known or practicable. According to some embodiments, the network 104 may comprise a conglomeration of different sub-networks and/or network components interconnected, directly or indirectly, by the components 102, 102-1, 104, 110, 112, 114, 116a-c, 118, 130, 132, 134, 140 of the system 100. The network 104 may comprise one or more cellular telephone networks with communication links between the communication device 114 and the remote server 130, for example, and/or may comprise an NFC or other short-range wireless communication path, with communication links between the inspection drone 110 and the solar panel 102, for example.

According to some embodiments, the inspection drone 110 may comprise any type, configuration, and/or quantity of autonomous, semi-autonomous, and/or remote control vehicle that is operable to follow one or more predefined and/or automatically computed navigational routes that place the inspection drone 110 in proximity to the solar panel 102. The inspection drone 110 may comprise, for example, a Pegasus™ II or III transformable drone available from Robotic Research OpCp, LLC of Clarksburg, Md. or a Phantom™ IV Pro V2.0 quad-copter drone available from SZ DJI Technology Co., Ltd. of Nanshan, Shenzhen, China. In some embodiments, the inspection drone 110 may comprise the processing device 112 such as a Central Processing Unit (CPU) that executes instructions (not shown) stored in the memory device 140 to operate in accordance with embodiments described herein. The processing device 112 may, for example, execute one or more programs, modules, and/or routines that facilitate the navigation and/or positioning of the inspection drone 110 to capture data descriptive of the solar panel 102. The processing device 112 may comprise, in some embodiments, one or more Eight-Core Intel® Xeon® 7500 Series electronic processing devices.

According to some embodiments, the communication device 114 may comprise any wired and/or wireless communication object and/or network device such as, but not limited to, a Radio Frequency (RF) antenna, transmitter, and/or receiver. In some embodiments, the communication device 114 may comprise hardware, software, and/or firmware operable to enable wireless communications including, but not limited to, encoding and/or decoding modules, filters, and/or encryption and/or decryption modules.

According to some embodiments, the input device 116a may comprise one or more of a throttle and a steering control mechanism and/or interface via which a human operator may selectively control a semi-autonomous and/or remote control version of the inspection drone 110. The operator may, for example, utilize the input device 116a to override an autonomous navigational and/or data acquisition sequence and/or to reposition and/or activate the inspection drone 110 in certain circumstances (e.g., in the case of errors or unusual obstacles or issues).

In some embodiments, the location device 116b may comprise any type, quantity, and/or configuration of location identification and/or tracking device that is or becomes known or practicable. The location device 116a may comprise, for example, one or more Global Positioning System (GPS) devices, wireless signal triangulation devices, atomic clocks, etc.

According to some embodiments, the sensor 116c may comprise may any type, configuration, and/or quantity of sensor devices that are or become known or practicable. In some embodiments, the sensor 116c may comprise a Light Detection and Ranging (LiDAR), LAser Detection and Ranging (LADAR), radar, sonar, Infrared Radiation (IR), RF, structured light, and/or imaging device operable to acquire data descriptive of the solar panel 102 and/or the solar panel feature 102-1 (e.g., reflections, shadows) thereof. According to some embodiments, the sensor 116c may also or alternatively comprise a gyroscope, image, audio, and/or video capture and/or recording device, chemical detection device, and/or a heat and/or light sensor. According to some embodiments, the sensor 116c may comprise various movement sensors such as speed/velocity sensors, pressure sensors, temperature sensors, accelerometers, Inertial Measurement Unit (IMU) devices, and/or tilt sensors. In some embodiments, the location device 116a and/or the sensor 116c may be utilized to automatically maneuver the inspection drone 110.

In some embodiments, the maneuver device 118 may comprise any type, quantity, and/or configuration of mechanical, electrical, and/or electro-mechanical devices that are operable to control the path of the inspection drone 110. The maneuver device 118 may comprise, for example, steering linkage, actuators, control surfaces, thrust vectoring devices, etc. In some embodiments, the maneuver device 118 may be coupled to and/or in communication with the propulsion device 132. The maneuver device 118 may comprise, for example, a steer-by-wire system that permits computerized control of the maneuvering of the inspection drone 110. The maneuver device 118 and the propulsion device 12 may, for example, operate in a coordinated fashion (e.g., in response to commands from the processing deice 112) to cause the inspection drone 110 to automatically follow a desired autonomous path and/or route.

According to some embodiments, the propulsion device 132 may comprise any type, configuration, and/or quantity of propulsion devices that are operable to move the inspection drone 110 from one location to another. The propulsion device 132 may comprise, for example, one or more motors, engines, gears, drives, propellers, fans, jets, nozzles, wheels, treads, and/or magnetic propulsion devices. According to some embodiments, the power device 134 may be electrically coupled to provide power to any or all of the propulsion device(s) 132, the communication device 114, the processing device 112, the input device 116a, the location device 116b, the sensor 116c, and/or the maneuver device 118. In some embodiments, the power device 134 may comprise a power source such as a solar cell, inertial generator, on-board generator, fuel-cell, external power supply port, etc. According to some embodiments, the power device 134 may also or alternatively comprise a power storage device such as one or more capacitors, batteries, fuel reservoirs or tanks, etc.

In some embodiments, the memory device 140 may store various logic, code, and/or applications, each of which may, when executed, participate in, facilitate, and/or cause the inspection drone 110 to operate to acquire data descriptive of the solar panel 102, as described herein. In some embodiments, the memory device 140 may comprise any type, configuration, and/or quantity of data storage devices that are or become known or practicable. The memory device 140 may, for example, comprise an array of optical and/or solid-state memory cards or hard drives configured to store sensor data, maneuvering data, object classification data, navigation data, solar positioning data, routing data (e.g., analysis formulas and/or mathematical models), credentialing and/or communication instructions, codes, and/or keys, and/or various operating instructions, drivers, etc. In some embodiments, the memory device 140 may comprise a solid-state and/or non-volatile memory card (e.g., a Secure Digital (SD) card, such as an SD Standard-Capacity (SDSC), an SD High-Capacity (SDHC), and/or an SD eXtended-Capacity (SDXC) and any various practicable form-factors, such as original, mini, and micro sizes, such as are available from Western Digital Corporation of San Jose, Calif. While the memory device 140 is depicted as a stand-alone component of the inspection drone 110, the memory device 140 may comprise multiple components. In some embodiments, a multi-component memory device 140 may be distributed across various devices and/or may comprise remotely dispersed components. Either of the inspection drone 110 and/or the remote server 130 may comprise the memory device 140 or a portion thereof, for example.

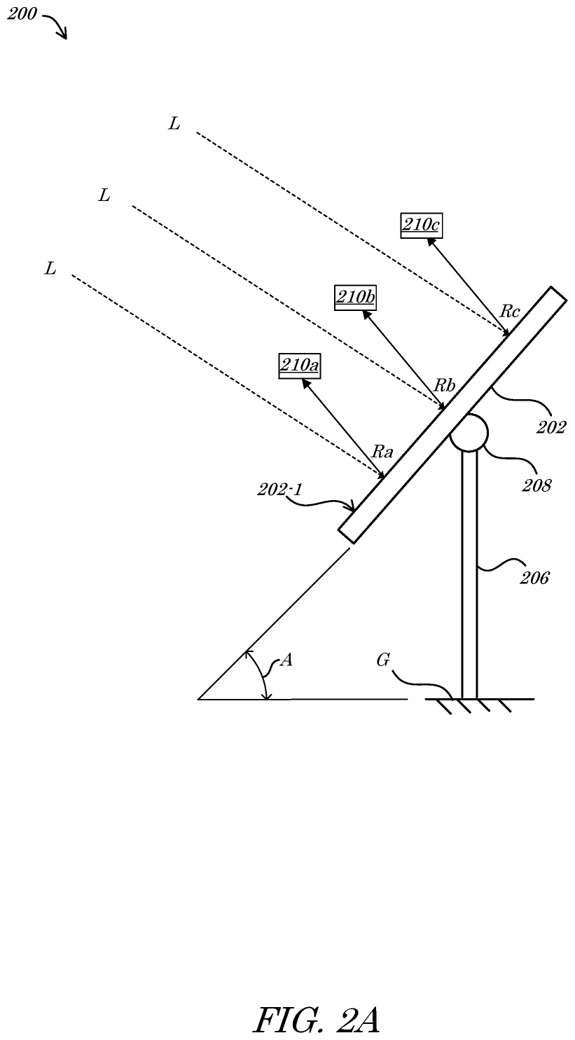

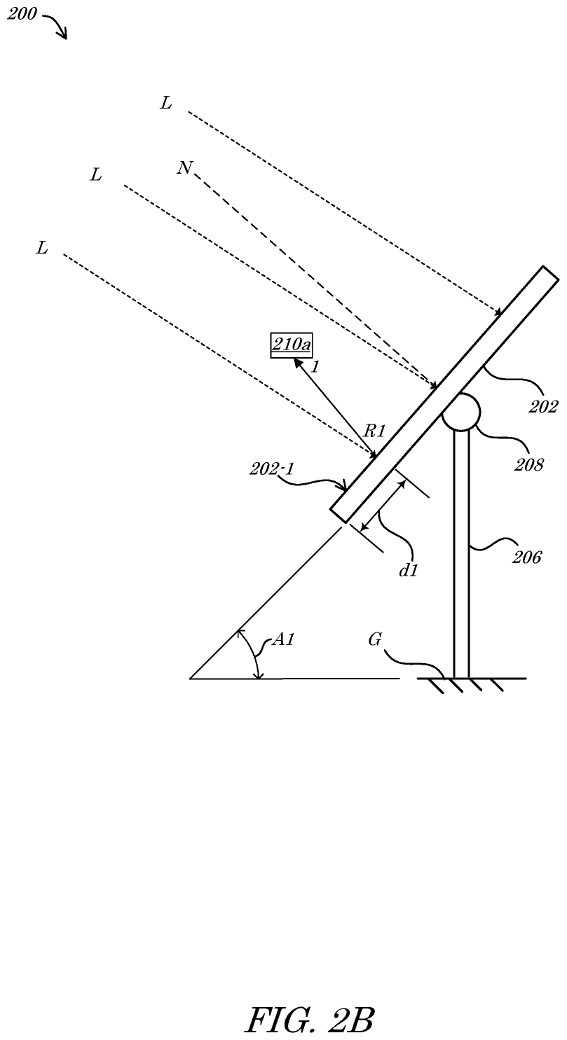

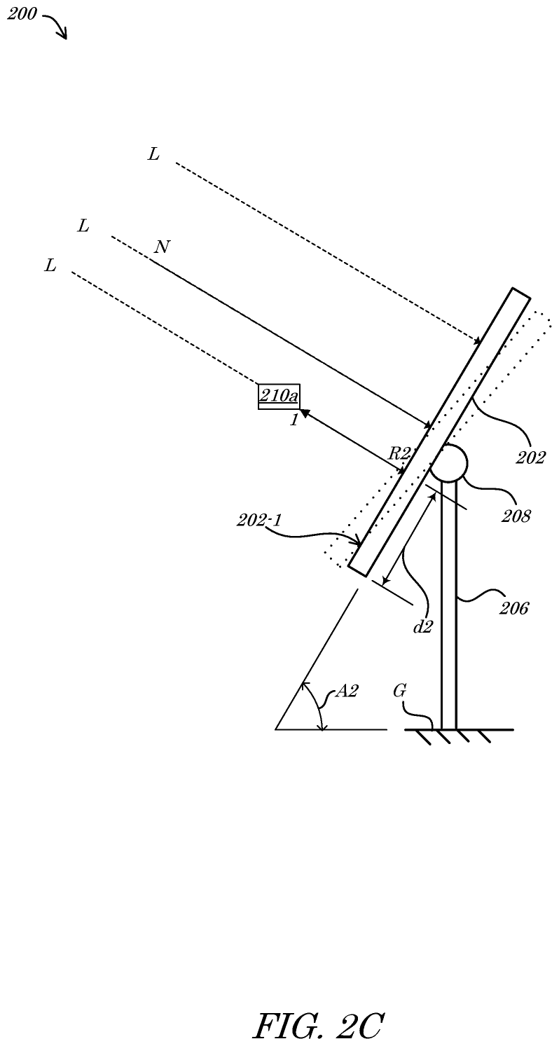

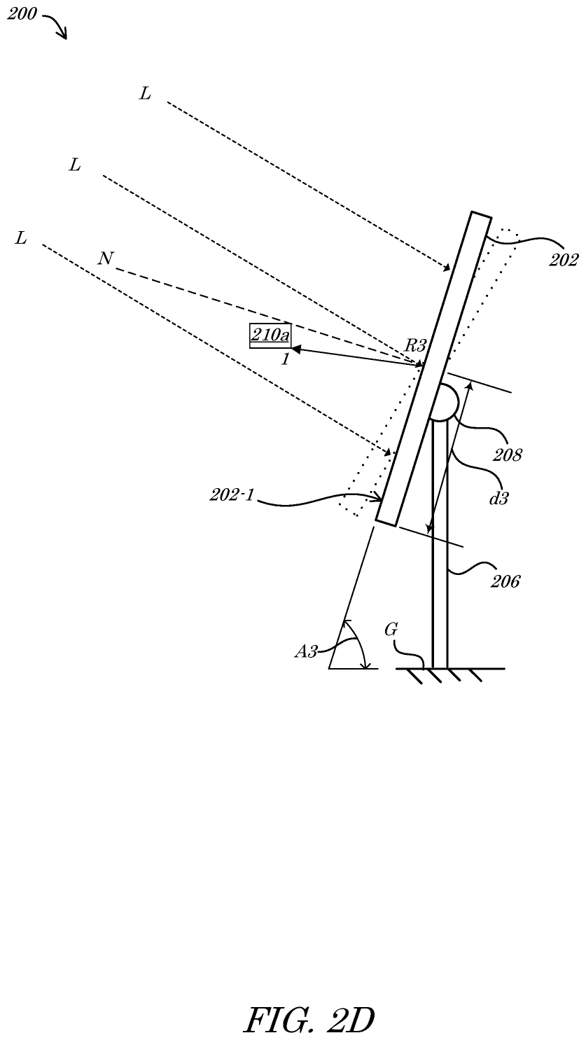

Turning to FIG. 2A, FIG. 2B, FIG. 2C, and FIG. 2D, block diagrams of a system 200 according to some embodiments are shown. The system 200 may comprise, for example, a solar panel 202 having a surface 202-1 disposed at an angle “A” with respect to a horizontal (or other) datum such as the ground “G”. In some embodiments, the solar panel 202 may be mounted to a pole 206 (as depicted) and/or may be reoriented and/or adjusted (e.g., the angle “A” may be changed) via a coupling 208. While a simple pole-mounted installation is depicted for ease of illustration, in some embodiments, the solar panel 202 may be mounted utilizing other methods and/or objects that are or become known and/or practicable. According to some embodiments, light “L” from the sun may illuminate the surface 202-1 of the solar panel 202, e.g., enabling the solar panel 202 and/or components thereof (not separately shown) to produce electricity and/or capture heat.

When an observer observes/sees the sun's reflection “Ra”, “Rb”, “Rc” on the solar panel 202, the location of the reflection “Ra”, “Rb”, “Rc” depends on (i) the angle of the sun's rays “L”, (ii) the angle “A” of the solar panel 202, and (iii) the location of the observer 210a-c relative to the solar panel 202. In the case of a first observer 210a as depicted, it would see the sun's reflection at point “Ra” on the solar panel, while a second observer 210b would observe the sun's reflection at point “Rb”, and a third observer 210c would observe the sun's reflection at point “Rc” on the solar panel 202. As noted in item (ii) above, the angle “A” of the solar panel 202 affects the location of the sun's reflection “Ra”, “Rb”, “Rc” on the solar panel 202.

With reference to FIG. 2B, for example, in the case that the solar panel 202 is disposed in a first orientation defining a first angle “A1”, the panel is not aligned with the sun rays “L” (as shown by the normal line “N”) and is tilted too much toward the horizontal. In the first orientation, and with a first observer 210a at a first position “1” in front of the surface 202-1, the first observer 210a would observe the sun's reflection at point “R1”. In a second orientation as depicted in FIG. 2C, the solar panel 202 is tilted more vertically and the first observer 210a remaining at the same first location “1” would now observe the sun's reflection has moved to point “R2”. In a third orientation as depicted in FIG. 2D, the solar panel 202 is tilted even more vertically and the first observer 210a remaining at the same first location “1” would now observe the sun's reflection has moved to point “R3”.

In the case that the observers 210a-c are drones (such as the inspection drone 110 of FIG. 1 herein), the observers 210a-c may comprise sensors (not separately shown) operable to measure, derive, compute, and/or calculate the angle “A”, e.g., based on the observed/measured location of the sun's reflection “Ra”, “Rb”, “Rc”, “R1”, “R2”, “R3”. The first drone/observer 210a may, for example, measure the angle of the reflection (e.g., at “R1”) and compare it to the angle of the sun's rays “L”. If the solar panel 202 is properly aligned, then the surface 202-1 would be perpendicular to the sun's rays “L” (e.g., the normal line “N” would be parallel to the sun's rays “L”, as shown in FIG. 2C) and therefore the reflection (e.g., at “R2”) would be parallel to the sun's rays “L”. The angle between the reflection (e.g., at “R1”) and the sun's rays “L” is directly related to the misalignment angle of the solar panel 202. In general, this is a two degree (2°) of freedom error measurement and can be corrected automatically if the panel is motorized, e.g., via the coupling 208 (in either or both pan and tilt).

In some embodiments, the first drone/observer 210a may comprise a sensor (not shown; e.g., the sensor 116c of FIG. 1 herein) that measures and/or otherwise identifies a location and/or orientation (e.g. bearing) of the reflection (e.g., at “R1”). The first drone/observer 210a may, for example, measure a first distance “d1” from a lower edge of the solar panel 202 to the first point of reflection “R1”, a second distance “d2” from the lower edge of the solar panel 202 to the second point of reflection “R2”, and/or a third distance “d3” from the lower edge of the solar panel 202 to the third point of reflection “R3”. According to some embodiments, these and/or other measurements (e.g., directly measured via LiDAR and/or derived from object recognition techniques) may be compared to stored measurement and/or location data and/or to each other to determine whether (and by what amount) the solar panel 202 is out of alignment.

Fewer or more components 202, 202-1, 206, 208, 210a-c and/or various configurations of the depicted components 202, 202-1, 206, 208, 210a-c may be included in the system 200 without deviating from the scope of embodiments described herein. In some embodiments, the components 202, 202-1, 206, 208, 210a-c may be similar in configuration and/or functionality to similarly named and/or numbered components as described herein. In some embodiments, the system 200 (and/or portion thereof) may comprise an autonomous solar panel maintenance system and/or platform programmed and/or otherwise configured to execute, conduct, and/or facilitate the method 600 of FIG. 6 herein, and/or portions thereof.

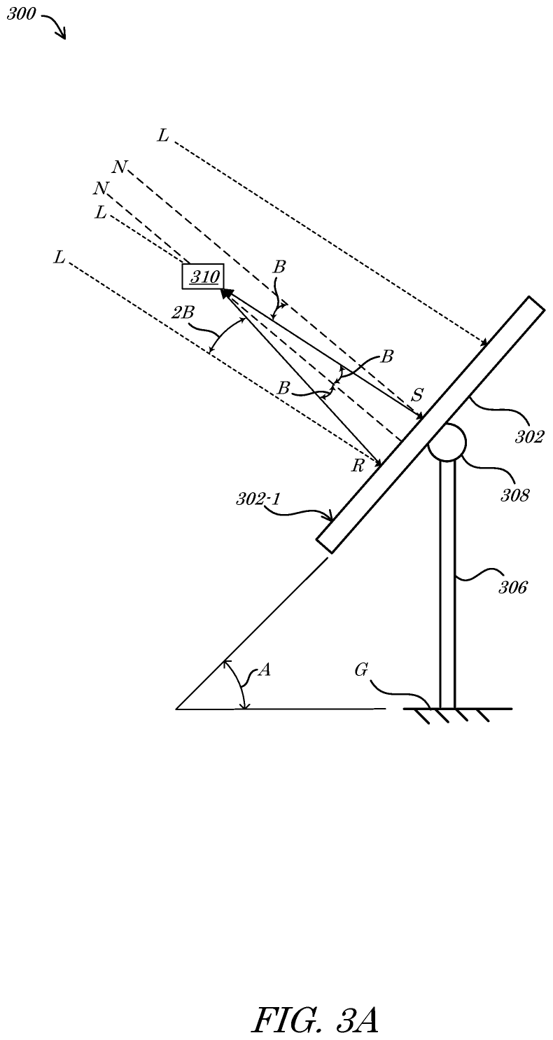

Turning to FIG. 3A, FIG. 3B, FIG. 3C, FIG. 3D, FIG. 3E, and FIG. 3F, block diagrams of a system 300 according to some embodiments are shown. The system 300 may comprise, for example, a solar panel 302 having a surface 302-1 disposed at an angle “A” with respect to a horizontal (or other) datum such as the ground “G”. In some embodiments, the solar panel 302 may be mounted to a pole 306 (as depicted) and/or may be reoriented and/or adjusted (e.g., the angle “A” may be changed) via a coupling 308. While a simple pole-mounted installation is depicted for ease of illustration, in some embodiments, the solar panel 302 may be mounted utilizing other methods and/or objects that are or become known and/or practicable. According to some embodiments, light “L” from the sun may illuminate the surface 302-1 of the solar panel 302, e.g., enabling the solar panel 302 and/or components thereof (not separately shown) to produce electricity and/or capture heat.

In some embodiments, and as depicted in FIG. 3A, the surface 302-1 of the solar panel 302 may be oriented at the angle “A” with respect to the horizontal which may position the surface 302-1 at an offset angle “B” with respect to the sun's rays “L” (e.g., at a particular point in time). In such a case, the sun's rays “L” that strike an observer 310 at a particular point in front of the solar panel 302 casts a shadow at point “S” on the surface 302-1. Also, the observer 310 sees the sun's reflection at point “R”. The reflection “R” appears at an angle “2B” to the sun's rays “L”, i.e. ∠R−310−S=2B. A calibrated camera (not separately shown; e.g., of the observer 310) can be used to detect the shadow “S” and the sun's reflection “R”, measure the angles and/or distances thereto, and then compute the angle “B”. In practice, when a camera is carried by a drone (e.g., the observer 310), the location of the camera's shadow may be used which is not necessarily in the center of the drone's shadow.

As depicted in FIG. 3B, a drone 310 flying near the solar panel 302 may capture an image 344 of the solar panel 302 (and/or the surface 302-1 thereof). From a proper location (e.g., as depicted), the sun's reflection “R” on the solar panel 302 can be seen by the drone 310. The shadow “5” may also be visible. The relative location between the shadow “S” and the reflection “R” depends on the angle “B” between the sun's rays “L” and the reflected rays. When the sun rays “L” and the reflected rays are parallel, the solar panel 302 is properly aligned for maximum power. In some embodiments, the brightness (e.g., measured magnitude) of the reflection “R” depends on how clean and/or unobstructed the solar panel 302 is and may be measured and/or recorded by the drone 310.

For clarity and ease of reference, the drawings generally show the alignment problem in 2-D where the alignment error in tilt is determined. Tilt is a measure of how vertical the panel is. Similar math and/or processes may be utilized to solve for the alignment error in pan, i.e., compass heading of the solar panel 302.

As depicted in FIG. 3C, in the case that the shadow “S” and the sun's reflection “R” are both on the solar panel 302, the angle between them, ∠R−310−S or “2B”, does not depend on the location of the observer 310. In FIG. 3C, the observer 310 moves parallel to the surface 302-1 of the solar panel 302 from point “1” to point “2”, but the angle “2B” between a first shadow “S1” and a first reflection “R1” and a second shadow “S2” and a second reflection “R2”, does not change. The location of the shadow moves from “S1” to “S2”, and reflection moves from “R1” to “R2” (i.e., they are displaced), but the angle “2B” between them remains constant. If the observer 310 moves parallel to the surface 302-1 of the solar panel 302 then the angle 2B between the shadow “S” and the reflection “R” does not change. The locations of the shadow “S” and reflection “R” do change, but not the angle between them.

Referring to FIG. 3D, in the case that the observer 310 moves further from the solar panel 302 from a close position “C” to a far position “F”, the distance between a far shadow “SF” and a far reflection “RF” is larger than a distance between a close shadow “SC” and a close reflection “RC”, but the angle “2B” between them does not change. The location of the shadow moves from “SC” to “SF”, and reflection moves from “RC” to “RF”, but the angle “2B” between them remains constant. Assuming the drone's shadow “SC”, “SF” and the sun's reflection “RC”, RF″ are both on the solar panel 302, the angle between them, ∠R−310−S or 2B, does not depend on the location of the observer/drone 310.

In some cases, as depicted in FIG. 3E, the observer 310 may cast an off-panel shadow “SO”. In these cases, if the drone 310 is using a navigation system, then the location of the shadow “SO” can be computed. The location of the drone, (x₃₁₀, y₃₁₀), may be measured by the navigation system. The sun's orientation, “D”, is known given the latitude, longitude, time and date. The location of the solar panel 302 at position “O”, (xₒ, yₒ), can be determined by a survey before hand or by using sensors on the drone 310 during the flight. Finally, an estimation of the orientation of the solar panel 302, “A”, can determined by communicating with the panel control system (to retrieve setting information) or by using sensors on the drone 310. Even if the orientation of the solar panel 302, “A”, might not be accurately known, small errors in the estimate of “A” do not effect the orientation of the shadow “SO” relative to the drone 310.

As shown in FIG. 3F, for example, the computed location of a first shadow point “Sa” at a first time and a second shadow point “Sb” at a second time, depends on the respective first orientation “Aa” and second orientation “Ab” of the solar panel 302. However, the orientation of the shadow points “Sa”, “Sb” relative to the drone 310 does not change, unlike the orientation of the reflections, “Ra” and “Rb”. The approximation of “Aa”, “Ab” is accordingly sufficient to compute the shadow's point positions “Sa”, “Sb”.

Fewer or more components 302, 302-1, 306, 308, 310, 344 and/or various configurations of the depicted components 302, 302-1, 306, 308, 310, 344 may be included in the system 300 without deviating from the scope of embodiments described herein. In some embodiments, the components 302, 302-1, 306, 308, 310, 344 may be similar in configuration and/or functionality to similarly named and/or numbered components as described herein. In some embodiments, the system 300 (and/or portion thereof) may comprise an autonomous solar panel maintenance system and/or platform programmed and/or otherwise configured to execute, conduct, and/or facilitate the method 600 of FIG. 6 herein, and/or portions thereof.

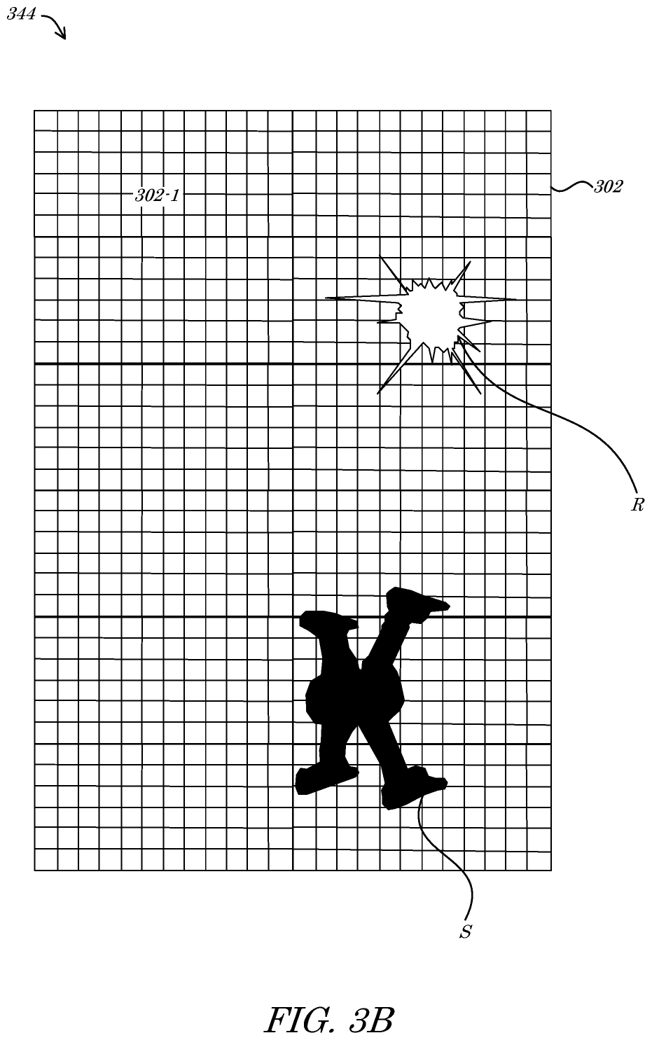

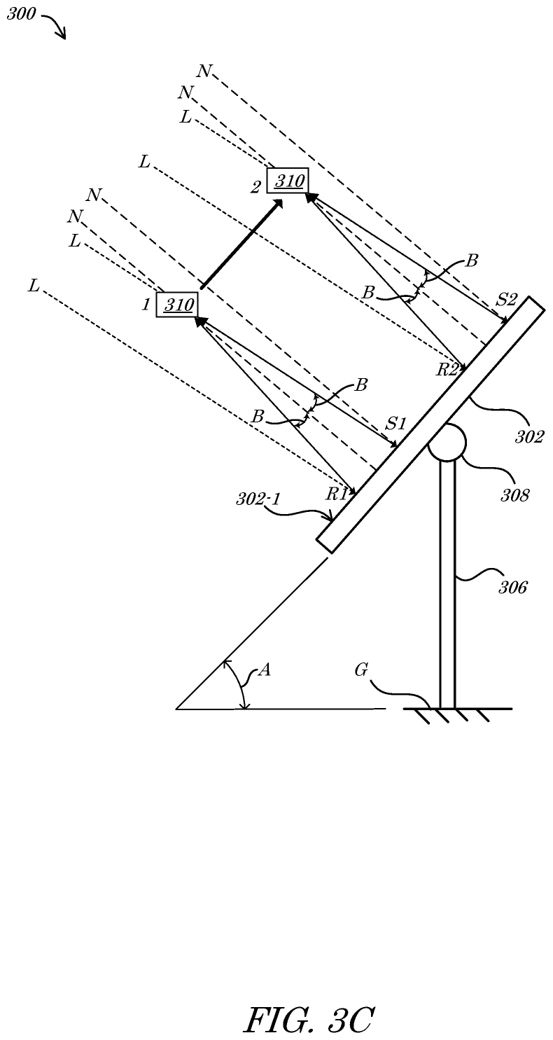

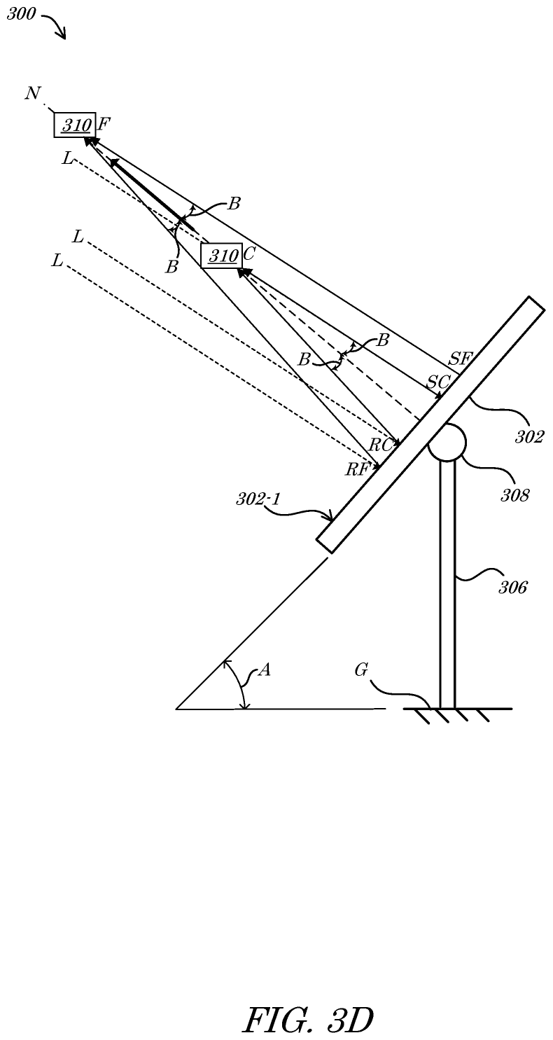

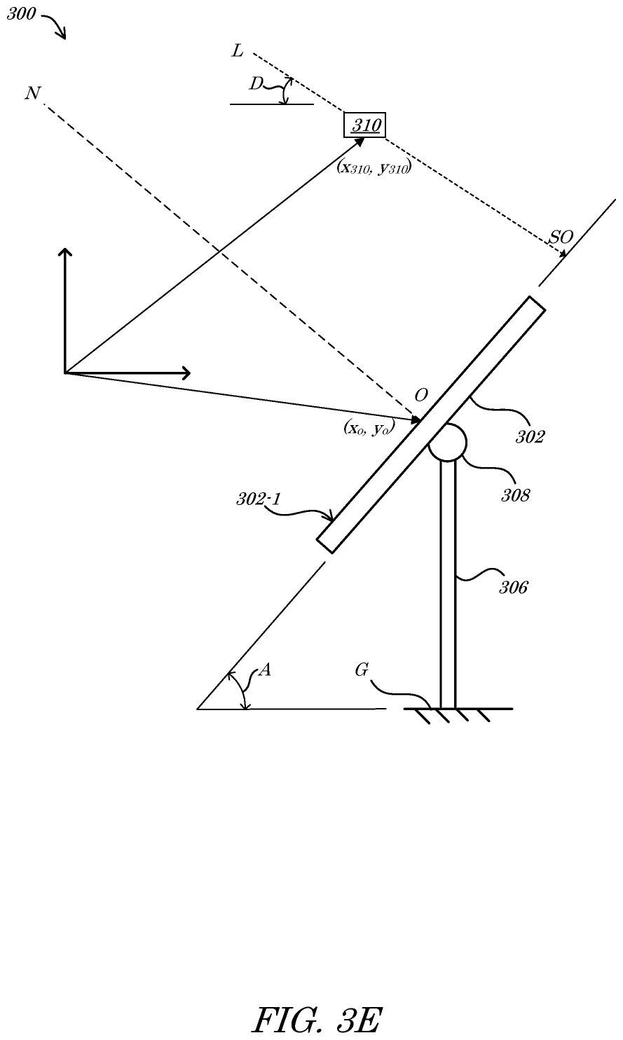

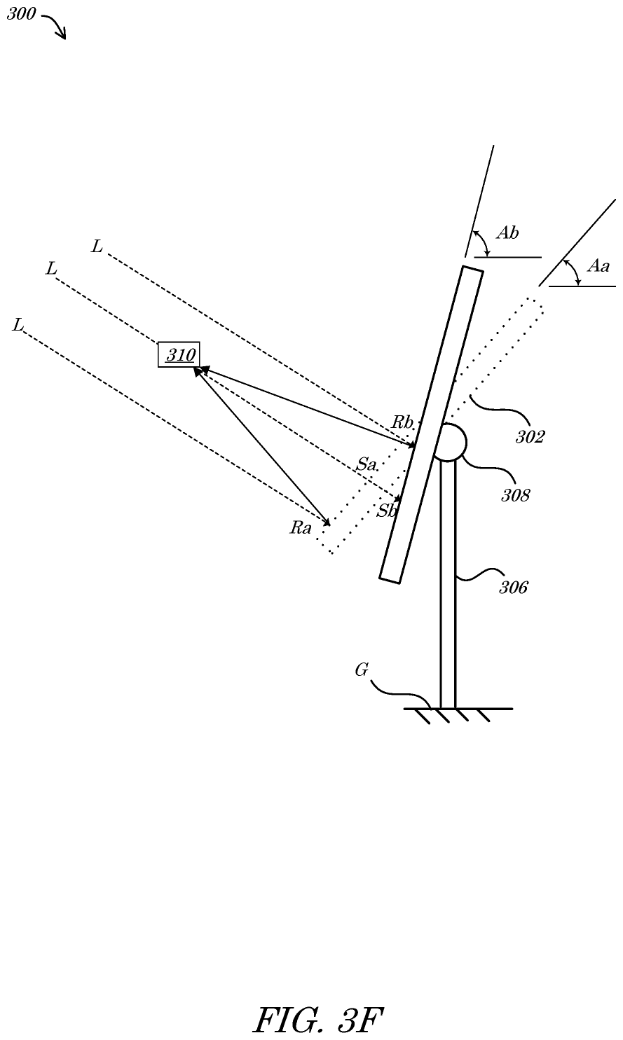

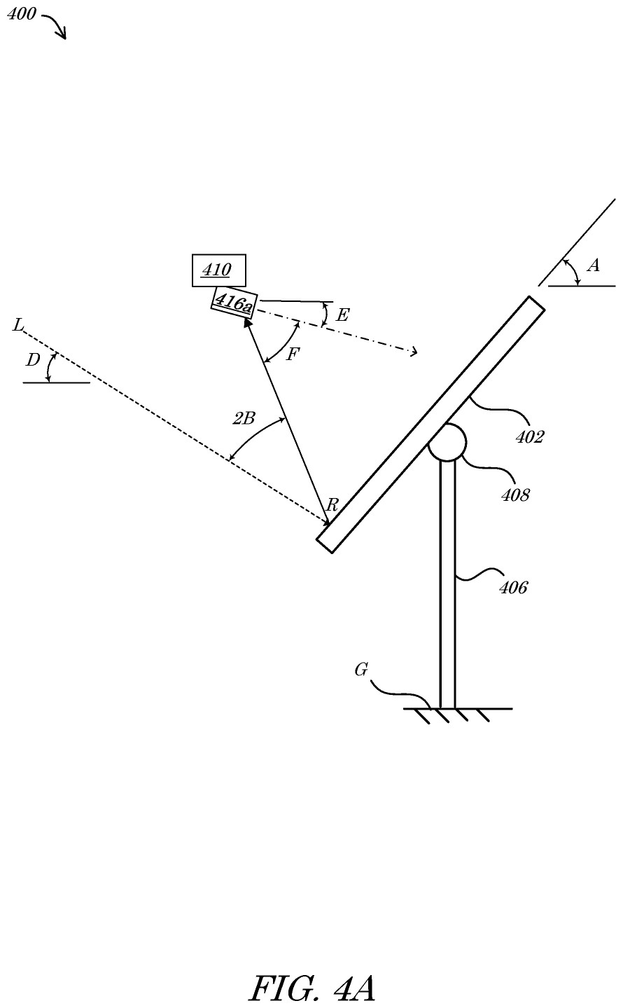

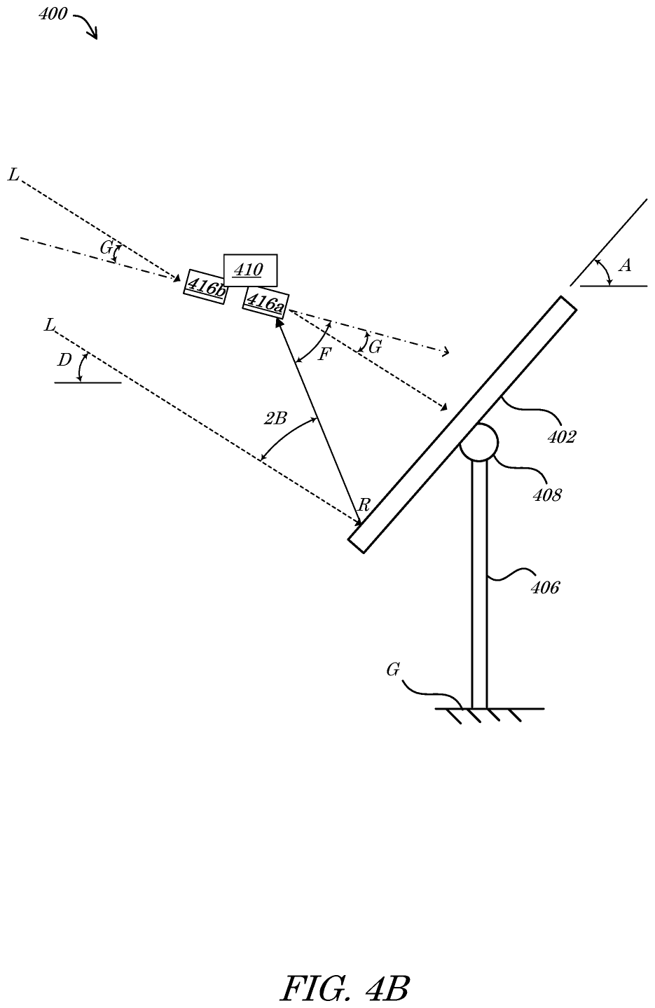

According to some embodiments, on-board equipment with enhanced capabilities may be utilized to compute and/or measure solar panel orientations while requiring fewer data inputs. Referring now to FIG. 4A and FIG. 4B for example, block diagrams of a system 400 according to some embodiments are shown. The system 400 may comprise, for example, a solar panel 402 having a surface 402-1 disposed at an angle “A” with respect to a horizontal (or other) datum such as the ground “G”. In some embodiments, the solar panel 402 may be mounted to a pole 406 (as depicted) and/or may be reoriented and/or adjusted (e.g., the angle “A” may be changed) via a coupling 408. While a simple pole-mounted installation is depicted for ease of illustration, in some embodiments, the solar panel 402 may be mounted utilizing other methods and/or objects that are or become known and/or practicable. According to some embodiments, light “L” from the sun may illuminate the surface 402-1 of the solar panel 402, e.g., enabling the solar panel 402 and/or components thereof (not separately shown) to produce electricity and/or capture heat.

According to some embodiments, a drone 410 may comprise electronics 416a such as inertial and/or gyroscopic sensors operable to measure an orientation “E” of the drone 410 (and/or a sensor and/or portion thereof) with respect to a datum (e.g., the horizontal). In this case, the location of the shadow (not shown) does not need to be measured or calculated. The offset “B” of the solar panel 402 can be computed using the orientation “E” of the drone 410 (and/or camera, sensor thereof), the location of the sun's reflection “R” in the camera, “F”, and the sun's orientation, “D”, using the equation 2B+D=E+F.

In some embodiments, an additional sensor 416b on the drone 410 may enable computation of the offset “B” without the need to consult stored data of sun positions, azimuths, latitude, longitude, times, etc. As depicted in FIG. 4B, for example, the drone 410 may utilize sensors 416a-b that can measure both the angle “F” of the sun's reflection “R” and the sun's angle “D” (utilizing a perceived sun offset angle “G”) simultaneously. For example, two back to back cameras 216a-b with appropriate solar filters could be used. The offset angle “B” can be computed using the location of the reflection “R” in the sensor, “F”, and the location of the sun in the sensor, “G”, using the equation 2B=F−G. In this variant, the orientation of the sensor 216a-b in inertial space is not needed.

In some embodiments, the source of reflected light does not need to come from the sun, but instead may come from the moon and/or from terrestrial sources such as one or more surveyed light poles (not shown), the drone 410, or a different drone (not shown). Unlike the sun or the moon, the light rays emitted from terrestrial light sources are typically not parallel. The angle of the incoming light changes with position and must be accounted for. If the light source was on a drone 410, it would also require a navigation system so that the location of the light source would be known.

According to some embodiments, in the case that the drone 410 is inspecting multiple solar panels 402 (multiples not shown), it can fly from panel 402 to panel 402 inspecting each as it goes. Or to save total inspection time, multiple panels 402 could, temporarily, re-orient themselves so that the drone 410 could inspect a group of panels from one location.

In some embodiments, if the solar panel 402 is not flat, the reflections at different locations will be at different angles. The drone 410 can make measurements at multiple locations on a single solar panel 402 to get an average orientation and/or to compute the curvature, bowing, and/or other topology changes and/or characteristics of the surface 402-1.

Fewer or more components 402, 406, 408, 410, 416a-b and/or various configurations of the depicted components 402, 406, 408, 410, 416a-b may be included in the system 400 without deviating from the scope of embodiments described herein. In some embodiments, the components 402, 406, 408, 410, 416a-b may be similar in configuration and/or functionality to similarly named and/or numbered components as described herein. In some embodiments, the system 400 (and/or portion thereof) may comprise an autonomous solar panel maintenance system and/or platform programmed and/or otherwise configured to execute, conduct, and/or facilitate the method 600 of FIG. 6 herein, and/or portions thereof.

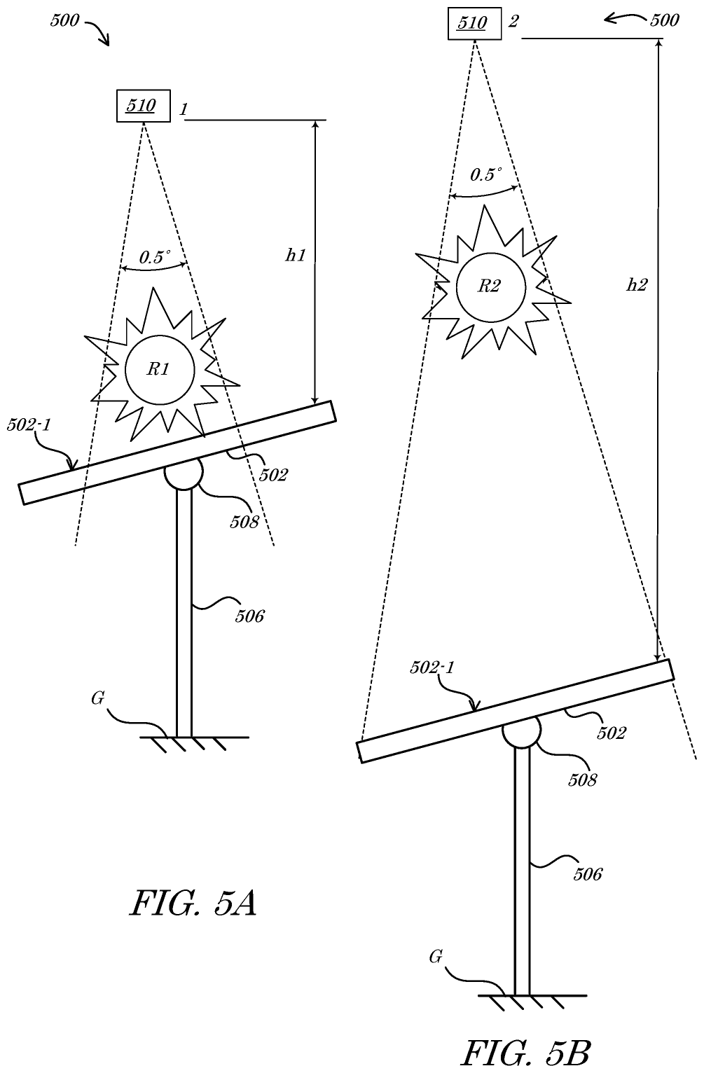

Referring to FIG. 5A and FIG. 5B, block diagrams of a system 500 according to some embodiments are shown. The system 500 may comprise, for example, a solar panel 502 having a surface 502-1 disposed at an angle (not separately labeled) with respect to a horizontal (or other) datum such as the ground “G”. In some embodiments, the solar panel 502 may be mounted to a pole 506 (as depicted) and/or may be reoriented and/or adjusted (e.g., the angle may be changed) via a coupling 508. While a simple pole-mounted installation is depicted for ease of illustration, in some embodiments, the solar panel 502 may be mounted utilizing other methods and/or objects that are or become known and/or practicable. According to some embodiments, light (not separately labeled) from the sun may illuminate the surface 502-1 of the solar panel 502, e.g., enabling the solar panel 502 and/or components thereof (not separately shown) to produce electricity and/or capture heat.

According to some embodiments, a drone 510 may navigate to a first position “1” at a first height “h1” above the solar panel 502, as depicted in FIG. 5A. From the first position “1”, the drone 510 may observe a first reflection of the sun “R1” on the surface 502-1 of the solar panel 502. For ease of illustration in a two-dimensional drawing, the first reflection “R1” is depicted above the surface 502-1. The sun is so far enough from the earth, that it looks the same, i.e., it has the same angular size, approximately half of one degree (0.5°), regardless if you move closer or further from the sun. It's reflection also has the same angular size regardless if you move closer or further from the solar panel 502. However, the solar panel 502, is much closer and its angular size does change with distance. As you move further away from the solar panel 502, the angular size of the panel becomes smaller and therefore, the sun's reflection “R1”, “R2” will cover more of the surface 502-1 of the solar panel 502. According to some embodiments, as depicted in FIG. 5B, the drone 510 may navigate to a second position “2” at a second height “h2” above the solar panel 502. From the second position “2”, the drone 510 may observe a second reflection of the sun “R2” on the surface 502-1 of the solar panel 502. As depicted, in that case that the second height “h2” is selected such that the extents of the solar panel 502 are delimited by the half of one degree (0.5°) angle from the drone 510, the second reflection “R2” substantially extends to cover the entire surface 502-1 of the solar panel 502 (at least in the given dimension depicted; in three dimensions, the solar panel 502 may comprise differing dimensions).

When checking the alignment of the solar panel 502, the drone 510 may be selectively positioned close enough that the sun's reflection “R2” is completely on the solar panel 502. When checking for dirt on the solar panel 502, being further (e.g., at the second height “h2”) may allow the drone 510 to measure reflectance over a larger portion of the solar panel 502 at one time.

The sun's rays are effectively parallel and therefore the drone's shadow (not shown) covers the same area on the solar panel 502 regardless of how high the drone 510 is. Like the angular size of the solar panel 502, the angular size of the drone shadow gets smaller as the observer moves further away. If the drone 510 was close to the solar panel 502, the drone shadow would completely block the sun's reflection (e.g., “R1”). The drone 510 may fly high enough so that the sun's reflection “R1”, “R2” is larger than the drone shadow and can accordingly be seen/measured.

When light hits the solar panel 502, some of the light is reflected (not shown). Reflection of light obeys the law of reflection—the angle of incidence is equal to the angle of reflection. However, the internal structure of the solar panel 502 may not be perfectly smooth and the reflected light becomes somewhat diffuse. At the micro level, each individual light ray follows the law of reflection but because of the uneven surface, some limited scattering occurs on the macro level. The solar panel 502 is manufactured and the internal structure may not only be uneven but may also have a bias. In this case, the “average reflection” does not follow the law of refraction but has an offset. The bias can be measured ahead of time for the specific model of solar panel 502 used. The calculations of the solar panel 502 orientation could then be adjusted accordingly to account for this known and/or measurable bias.

Fewer or more components 502, 502-1, 506, 508, 510 and/or various configurations of the depicted components 502, 502-1, 506, 508, 510 may be included in the system 500 without deviating from the scope of embodiments described herein. In some embodiments, the components 502, 502-1, 506, 508, 510 may be similar in configuration and/or functionality to similarly named and/or numbered components as described herein. In some embodiments, the system 500 (and/or portion thereof) may comprise an autonomous solar panel maintenance system and/or platform programmed and/or otherwise configured to execute, conduct, and/or facilitate the method 600 of FIG. 6 herein, and/or portions thereof.

III. Drone-Based Solar Panel Maintenance Methods

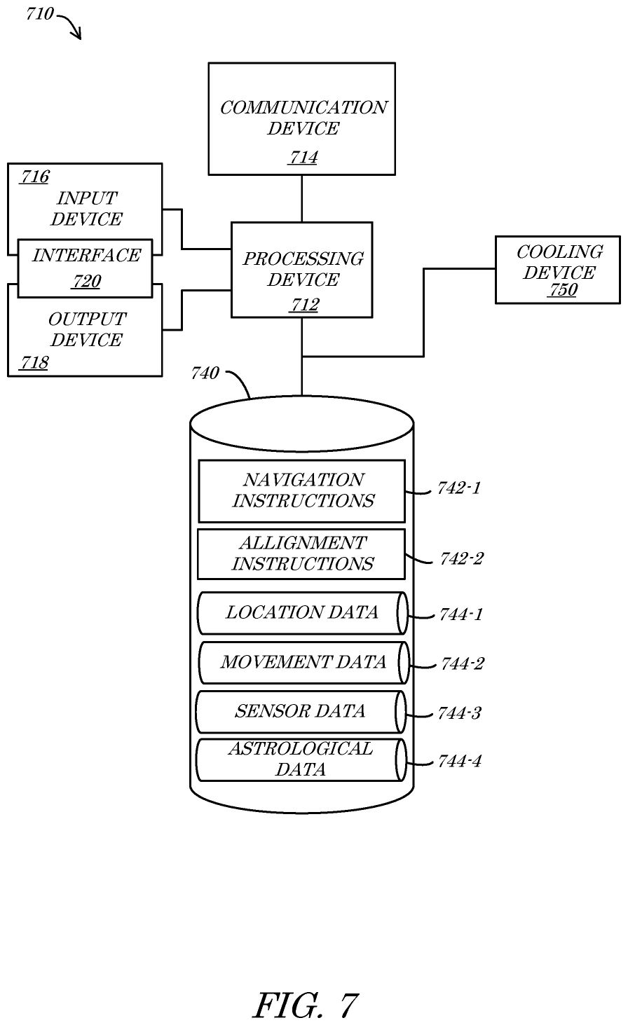

Referring now to FIG. 6, a flow diagram of a method 600 according to some embodiments is shown. In some embodiments, the method 600 may be performed and/or implemented by and/or otherwise associated with one or more specialized and/or specially-programmed computing devices (e.g., one or more of the drones 110, 210a-c, 310, 410, 510 and/or the apparatus 710 of FIG. 2A, FIG. 2B, FIG. 2C, FIG. 2D, FIG. 3A, FIG. 3B, FIG. 3C, FIG. 3D, FIG. 3E, FIG. 3F, FIG. 4A, FIG. 4B, FIG. 5A, FIG. 5B, and/or FIG. 7 herein), computer terminals, computer servers, computer systems and/or networks, and/or any combinations thereof (e.g., by one or more multi-threaded and/or multi-core processing units of an automated solar panel inspection processing system). In some embodiments, the method 600 may be embodied in, facilitated by, and/or otherwise associated with various input mechanisms and/or interfaces.

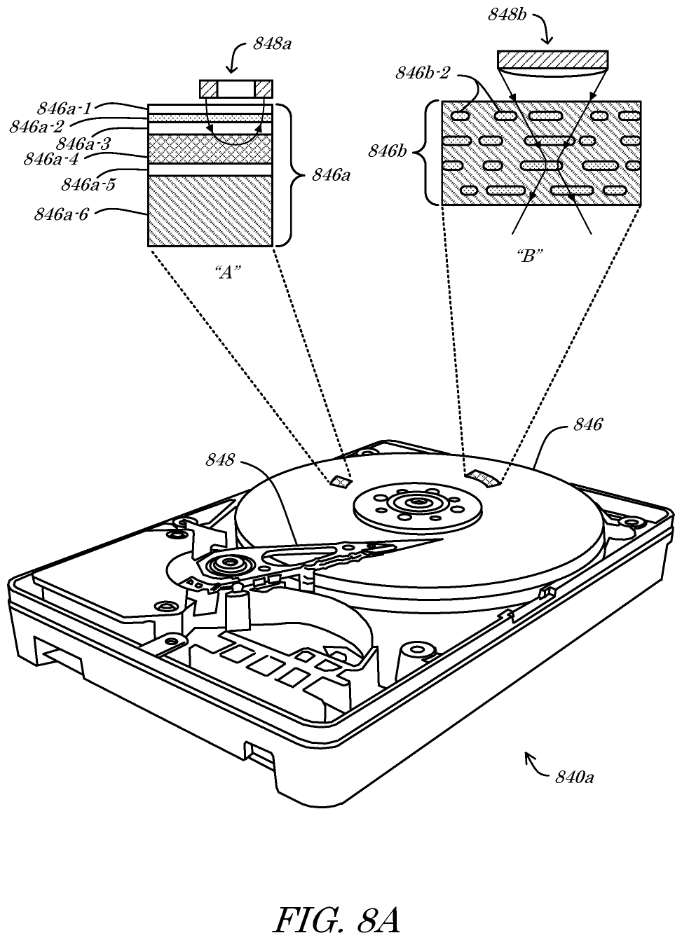

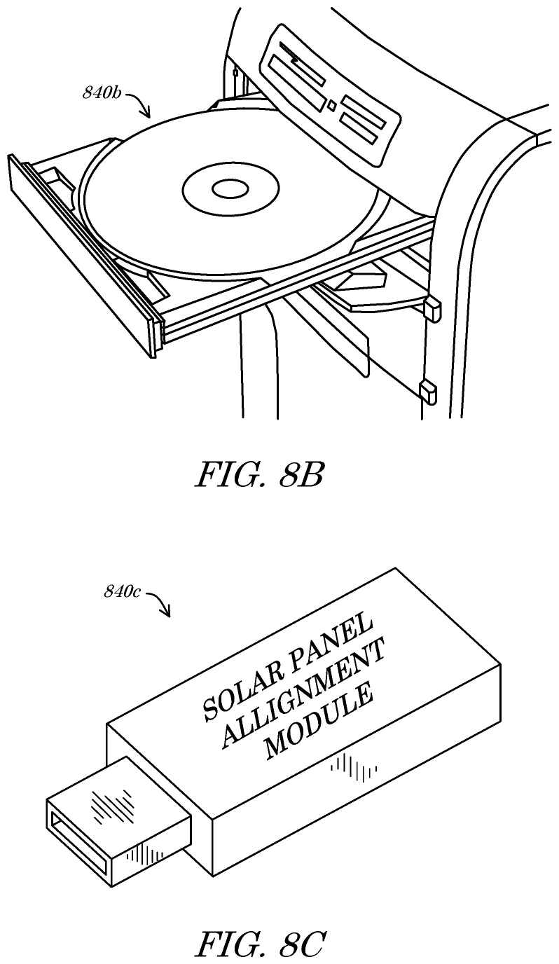

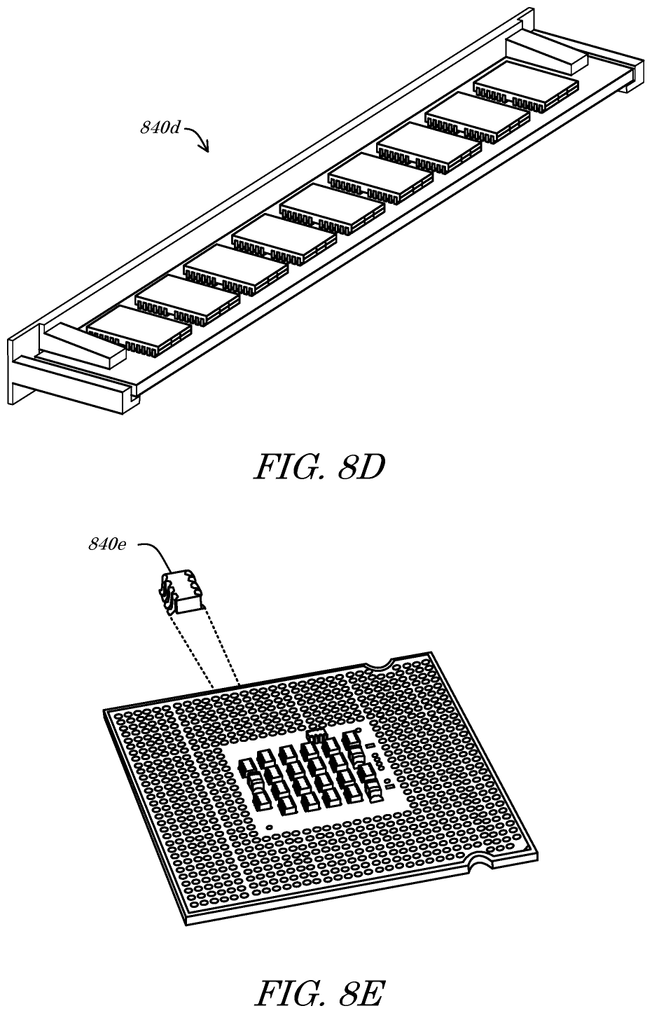

The process diagrams and flow diagrams described herein do not necessarily imply a fixed order to any depicted actions, steps, and/or procedures, and embodiments may generally be performed in any order that is practicable unless otherwise and specifically noted. While the order of actions, steps, and/or procedures described herein is generally not fixed, in some embodiments, actions, steps, and/or procedures may be specifically performed in the order listed, depicted, and/or described and/or may be performed in response to any previously listed, depicted, and/or described action, step, and/or procedure. Any of the processes and methods described herein may be performed and/or facilitated by hardware, software (including microcode), firmware, or any combination thereof. For example, a storage medium (e.g., a hard disk, Random Access Memory (RAM) device, cache memory device, Universal Serial Bus (USB) mass storage device, and/or Digital Video Disk (DVD); e.g., the memory/data storage devices 140, 740, 840a-e of FIG. 1, FIG. 7, FIG. 8A, FIG. 8B, FIG. 8C, FIG. 8D, and/or FIG. 8E, herein) may store thereon instructions that when executed by a machine (such as a computerized processor) result in performance according to any one or more of the embodiments described herein.

In some embodiments, the method 600 may comprise navigating to a target location, at 602. An unmanned vehicle may, for example, utilize a navigational routing program, routine, and/or module to operate upon an input location identifier (e.g., coordinates) to plan a navigational routing from a starting location of the vehicle to the target location. The target location may comprise, for example, a location at or near which a solar panel array is known to exist. According to some embodiments, the unmanned vehicle may traverse the navigational route by, e.g., selectively activating one or more propulsion and/or control surface or steering mechanisms.

In some embodiments, a controller device (on and/or in communication with the drone) may utilize the day and time to calculate or compute the azimuth and elevation of the sun for the particular target location (e.g., of a solar panel). According to some embodiments, it generates the navigational route and/or a trajectory for the drone that intersects the projected reflection of the sun given the desired inclination of the panel. In other words, if the panel is correctly aligned, when the drone is in the computed trajectory, the reflection of the sun should be visible on that particular array/panel. While most solar arrays have all panels oriented in substantially the same direction, in the case that different sections or sub-groups of panels in the array have different orientations, the navigational route and/or trajectory may be separately derived for each such sub-group. Similarly, in the case that an inspection is estimated to take many hours, different trajectories and/or navigational waypoints derived for different times of the day may be utilized to optimize the positioning of the drone between the sun (or moon) and the target solar panels.

According to some embodiments, the method 600 may comprise capturing data at the target location, at 604. The unmanned vehicle may utilize one or more sensors (e.g., LiDAR, imaging devices) to scan the target location and/or area, for example. According to some embodiments the sensor data may define a map, point cloud, surface model, and/or digital elevation model of the target area. In some embodiments, the method 600 may comprise searching for a solar panel, at 606. The data acquired by the sensor may be analyzed, for example, by comparing identified data signatures (e.g., object geometries, thermal signatures, radar signatures, machine-readable data, etc.) to stored solar panel signatures to identify one or more solar panels represented within the acquired data set. According to some embodiments, the processing may comprise one or more object classification, analysis, and/or identification routines that operate upon the captured input data to generate a weighted map (e.g., a ‘heat’ map) representing likelihoods of areas (e.g., pixels and/or groups of proximate pixels) matching stored signatures/objects. In some embodiments, the method 600 may comprise determining whether a solar panel has been identified, at 608. In the case that a match is identified between captured data and stored data signatures (e.g., one or more pixels and/or areas match stored data thresholds within a predefined likelihood parameter threshold), a solar panel may be identified.

In some embodiments, in the case that no solar panel is identified, the method 600 may loop back and/or proceed to searching for solar panels at 606. According to some embodiments, in the case that a solar panel is identified, the method 600 may proceed to and/or comprise searching for a solar panel feature, at 610. The data acquired by the sensor may be analyzed, for example (and/or additional data may be acquired, e.g., by re-scanning a portion of the target area that is indicative of the solar panel), by comparing identified data signatures (e.g., object geometries, thermal signatures, radar signatures, machine-readable data, etc.) to stored solar panel feature signatures to identify one or more solar panel features represented within the acquired data set. According to some embodiments, the processing may comprise one or more object classification, analysis, and/or identification routines that operate upon the captured input data to generate a weighted map (e.g., a ‘heat’ map) representing likelihoods of areas (e.g., pixels and/or groups of proximate pixels) matching stored signatures/objects. In some embodiments, the method 600 may comprise determining whether a solar panel feature has been identified, at 612. In the case that a match is identified between captured data and stored data signatures (e.g., one or more pixels and/or areas match stored data thresholds within a predefined likelihood parameter threshold), a solar panel feature may be identified. In some embodiments, the solar panel feature analysis may be limited and/or focused to areas indicating the location of the solar panel (and/or areas within a predefined range thereof).

According to some embodiments, in the case that no solar panel feature is identified, the method 600 may loop back and/or proceed to searching for solar panel features at 610. According to some embodiments, in the case that a solar panel feature is identified, the method 600 may proceed to and/or comprise measuring the solar panel feature, at 614. A camera on the drone may, for example, photograph the solar panel at the correct time in its trajectory (when an imaginary/estimated line between the sun and the solar panel is crossed).

In some embodiments, the method 600 may comprise computing the solar panel orientation, at 616. Given that the location of the drone and the solar panel are known, trigonometry can be utilized to compute the exact position in that image of the reflection of the solar panel feature (e.g., a reflection of the sun, shadow, etc.) provided by that solar panel. A misaligned solar panel will show the position of the feature/sun offset from the expected position, or not reflect the sun at all if the apparent location of the sun may be outside of the reflecting surface of the panel. An advantage of this method is that the detection of the sun reflection can be performed with a camera, and the accuracies achieved can easily exceed the requirements for solar panel alignment given low flying drones. Image recognition algorithms can be used to determine the outline of the reflected image of the sun, and therefore to compute the center of the reflection. Given the known location of the panel, the known location of the sun, the known location of the drone and the center of the sun found in the image, the desired inclination of the panel can be compared with the measured angle determined by this computation. In some embodiments, such as in the case that the solar panel is equipped with active repositioning components such as a motor and/or track or pistons, the drone may communicate with the solar panel system and send an instruction to re-set and/or adjust the orientation based on the computed orientation. In such a manner, for example, not only would the identification of misaligned solar panels be automatically achieved, but the rectification of any misaligned panels may be automatically achieved, greatly increasing overall system efficiency and reducing maintenance costs.

In some embodiments, the method 600 may comprise determining whether there are more solar panel features, at 618. The drone may, for example, take multiple measurements of various solar panel features to compute an average and/or overall score, rank, and/or result, e.g., to reduce errors. According to some embodiments, in the case that more solar panel features exist, the method 600 may loop back and/or proceed to searching the solar panel for additional solar panel features, at 610. In the case that no more solar panel features exist (and/or only a single solar panel feature is desired for computation of the solar panel orientation), the method 600 may comprise and/or proceed to determining whether there are more solar panels, at 620. In the case that the solar array at the target location is known to have a certain number of modules and/or panels, for example, the unmanned vehicle may cycle to analyze/measure the next solar panel on a listing (e.g., ranked and/or prioritized) of solar panels, e.g., identified in the target area/location, and/or may otherwise search for additional solar panels. According to some embodiments, in the case that more solar panels exist, the method 600 may loop back and/or proceed to searching the target location for additional solar panels, at 606. In the case that no more solar panels exist (e.g., remain to be measured), the method 600 may comprise and/or proceed to navigating to a return location, at 622. The unmanned vehicle may depart the target location and/or area, for example, such as to refuel, recharge, repair, and/or resupply.

According to some embodiments, the method 600 may also or additionally comprise sending one or more alerts and/or reports regarding the computed and/or calculated solar panel orientations. In the case that orientations cannot be automatically adjusted via electronic communications, for example, identifiers of all unaligned solar panels such as serial numbers and/or locations, and/or data descriptive of the misalignment computations, may be provided to personnel so that they may visit the solar array at the target location, locate the misaligned panels, and correct their alignment (e.g., manually).

Dust and dirt on the panels affect the efficiency of the panels themselves. It is also true that most dust and debris can also affect the intensity of the reflection. In other words, a dirty panel not only will gather less energy but, it will also reflect less energy. In a similar manner to that of checking for alignment, the reflected image of the sun can be used to determine the amount of dirt collected in a panel. By measuring the intensity of the returned reflection, the drone can measure the level of dirt accumulated with the panel. High flights will make the apparent size of the reflected sun bigger and therefore, it will allow for less flights necessary to determine the level of dirt across each part of the panel. According to some embodiments, a source of light on the drone is used to measure the emitter and returned intensity of the reflection to determine the level of dirt/obstruction.

IV. Drone-based Solar Panel Maintenance Apparatus & Articles of Manufacture

Turning to FIG. 7, a block diagram of an apparatus 710 according to some embodiments is shown. In some embodiments, the apparatus 710 may be similar in configuration and/or functionality to one or more of the drones 110, 210a-c, 310, 410, 510 and/or the remote server 130 of FIG. 2A, FIG. 2B, FIG. 2C, FIG. 2D, FIG. 3A, FIG. 3B, FIG. 3C, FIG. 3D, FIG. 3E, FIG. 3F, FIG. 4A, FIG. 4B, FIG. 5A, and/or FIG. 5B herein. The apparatus 710 may, for example, execute, process, facilitate, and/or otherwise be associated with the method 600 of FIG. 6 herein. In some embodiments, the apparatus 710 may comprise a processing device 712, a communication device 714, an input device 716, an output device 718, an interface 720, a memory device 740 (storing various programs and/or instructions 742 and data 744), and/or a cooling device 750. According to some embodiments, any or all of the components 712, 714, 716, 718, 720, 740, 742, 744, 750 of the apparatus 710 may be similar in configuration and/or functionality to any similarly named and/or numbered components described herein. Fewer or more components 712, 714, 716, 718, 720, 740, 742, 744, 750 and/or various configurations of the components 712, 714, 716, 718, 720, 740, 742, 744, 750 may be included in the apparatus 710 without deviating from the scope of embodiments described herein.

According to some embodiments, the processor 712 may be or include any type, quantity, and/or configuration of processor that is or becomes known. The processor 712 may comprise, for example, an Intel® IXP 2800 network processor or an Intel® XEON™ Processor coupled with an Intel® E7301 chipset. In some embodiments, the processor 712 may comprise multiple inter-connected processors, microprocessors, and/or micro-engines. According to some embodiments, the processor 712 (and/or the apparatus 710 and/or other components thereof) may be supplied power via a power supply (not shown) such as a battery, an Alternating Current (AC) source, a Direct Current (DC) source, an AC/DC adapter, solar cells, and/or an inertial generator. In the case that the apparatus 710 comprises a server, such as a blade server, necessary power may be supplied via a standard AC outlet, power strip, surge protector, and/or Uninterruptible Power Supply (UPS) device.

In some embodiments, the communication device 714 may comprise any type or configuration of communication device that is or becomes known or practicable. The communication device 714 may, for example, comprise a Network Interface Card (NIC), a telephonic device, a cellular network device, a router, a hub, a modem, and/or a communications port or cable. In some embodiments, the communication device 714 may be coupled to receive location data, e.g., from a sensor device (not separately shown in FIG. 7). The communication device 714 may, for example, comprise a BLE and/or RF receiver device and/or a camera or other imaging device that acquires data from descriptive of a location and/or a transmitter device that provides the data to a remote server and/or server or communications layer (not separately shown in FIG. 7). According to some embodiments, the communication device 714 may also or alternatively be coupled to the processor 712. In some embodiments, the communication device 714 may comprise an IR, RF, Bluetooth™, Near-Field Communication (NFC), and/or Wi-Fi® network device coupled to facilitate communications between the processor 712 and another device (such as a remote user device, e.g., a tele-operations station, not separately shown in FIG. 7).

In some embodiments, the input device 716 and/or the output device 718 are communicatively coupled to the processor 712 (e.g., via wired and/or wireless connections and/or pathways) and they may generally comprise any types or configurations of input and output components and/or devices that are or become known, respectively. The input device 716 may comprise, for example, a knob, wheel, lever, shifter, pedal, button, switch, and/or other object that permits an operator (e.g., a remote operator personnel) to control a speed, direction, and/or orientation of the apparatus 710. In some embodiments, the input device 712 may comprise a sensor, such as a camera, sound, light, radar, RF, and/or proximity sensor, configured to measure and/or record values via signals to the apparatus 710 and/or the processor 712. The output device 718 may, according to some embodiments, comprise a display screen and/or other practicable output component and/or device. The output device 718 may, for example, provide an interface (such as the interface 720) via which autonomous vehicle solar panel measurement data is provided to a user (e.g., via a mobile device application). According to some embodiments, the input device 716 and/or the output device 718 may comprise and/or be embodied in a single device, such as a touch-screen monitor.

The memory device 740 may comprise any appropriate information storage device that is or becomes known or available, including, but not limited to, units and/or combinations of magnetic storage devices (e.g., a hard disk drive), optical storage devices, and/or semiconductor memory devices such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 740 may, according to some embodiments, store one or more of navigation instructions 742-1 and/or alignment instructions 742-2, location data 744-1, movement data 744-2, sensor data 744-3, and/or astrological data 744-4. In some embodiments, the navigation instructions 742-1 and/or alignment instructions 742-2, location data 744-1, movement data 744-2, sensor data 744-3, and/or astrological data 744-4 may be utilized by the processor 712 to provide output information via the output device 718 and/or the communication device 714.

According to some embodiments, the navigation instructions 742-1 may be operable to cause the processor 712 to process the location data 744-1, movement data 744-2, sensor data 744-3, and/or astrological data 744-4 in accordance with embodiments as described herein. Location data 744-1, movement data 744-2, sensor data 744-3, and/or astrological data 744-4 received via the input device 716 and/or the communication device 714 may, for example, be analyzed, sorted, filtered, decoded, decompressed, ranked, scored, plotted, and/or otherwise processed by the processor 712 in accordance with the navigation instructions 742-1. In some embodiments, location data 744-1, movement data 744-2, sensor data 744-3, and/or astrological data 744-4 may be fed by the processor 712 through one or more mathematical and/or statistical formulas and/or models in accordance with the navigation instructions 742-1 to cause an autonomous, semi-autonomous, and/or remote control vehicle (e.g., a drone) to automatically navigate from a first location to a second location at which it is estimated a reflection and/or shadow may be observed on a surface of a solar panel to compute an orientation thereof, as described herein.

In some embodiments, the alignment instructions 742-2 may be operable to cause the processor 712 to process the location data 744-1, movement data 744-2, sensor data 744-3, and/or astrological data 744-4 in accordance with embodiments as described herein. Location data 744-1, movement data 744-2, sensor data 744-3, and/or astrological data 744-4 received via the input device 716 and/or the communication device 714 may, for example, be analyzed, sorted, filtered, decoded, decompressed, ranked, scored, plotted, and/or otherwise processed by the processor 712 in accordance with alignment instructions 742-2. In some embodiments, location data 744-1, movement data 744-2, sensor data 744-3, and/or astrological data 744-4 may be fed by the processor 712 through one or more mathematical and/or statistical formulas and/or models in accordance with the alignment instructions 742-2 to automatically compute solar panel orientation values/attributes based on sensed/measured reflection and/or shadow data, as described herein.

According to some embodiments, the apparatus 710 may comprise the cooling device 750. According to some embodiments, the cooling device 750 may be coupled (physically, thermally, and/or electrically) to the processor 612 and/or to the memory device 640. The cooling device 650 may, for example, comprise a fan, heat sink, heat pipe, radiator, cold plate, and/or other cooling component or device or combinations thereof, configured to remove heat from portions or components of the apparatus 610.

Any or all of the exemplary instructions and data types described herein and other practicable types of data may be stored in any number, type, and/or configuration of memory devices that is or becomes known. The memory device 640 may, for example, comprise one or more data tables or files, databases, table spaces, registers, and/or other storage structures. In some embodiments, multiple databases and/or storage structures (and/or multiple memory devices 640) may be utilized to store information associated with the apparatus 610. According to some embodiments, the memory device 640 may be incorporated into and/or otherwise coupled to the apparatus 610 (e.g., as shown) or may simply be accessible to the apparatus 610 (e.g., externally located and/or situated).

Referring to FIG. 8A, FIG. 8B, FIG. 8C, FIG. 8D, and FIG. 8E, perspective diagrams of exemplary data storage devices 840a-e according to some embodiments are shown. The data storage devices 840a-e may, for example, be utilized to store instructions and/or data such as the navigation instructions 742-1 and/or alignment instructions 742-2, location data 744-1, movement data 744-2, sensor data 744-3, and/or astrological data 744-4, each of which is presented in reference to FIG. 7 herein. In some embodiments, instructions stored on the data storage devices 840a-e may, when executed by a processor, cause the implementation of and/or facilitate a method in accordance with embodiments herein.

According to some embodiments, the first data storage device 840a may comprise one or more various types of internal and/or external hard drives. The first data storage device 840a may, for example, comprise a data storage medium 846 that is read, interrogated, and/or otherwise communicatively coupled to and/or via a disk reading device 848. In some embodiments, the first data storage device 840a and/or the data storage medium 846 may be configured to store information utilizing one or more magnetic, inductive, and/or optical means (e.g., magnetic, inductive, and/or optical-encoding). The data storage medium 846, depicted as a first data storage medium 846a for example (e.g., breakout cross-section “A”), may comprise one or more of a polymer layer 846a-1, a magnetic data storage layer 846a-2, a non-magnetic layer 846a-8, a magnetic base layer 846a-4, a contact layer 846a-5, and/or a substrate layer 846a-6. According to some embodiments, a magnetic read head 848a may be coupled and/or disposed to read data from the magnetic data storage layer 846a-2.

In some embodiments, the data storage medium 846, depicted as a second data storage medium 846b for example (e.g., breakout cross-section “B”), may comprise a plurality of data points 846b-2 disposed with the second data storage medium 846b. The data points 846b-2 may, in some embodiments, be read and/or otherwise interfaced with via a laser-enabled read head 848b disposed and/or coupled to direct a laser beam through the second data storage medium 846b.

In some embodiments, the second data storage device 840b may comprise a CD, CD-ROM, DVD, Blu-Ray™Disc, and/or other type of optically-encoded disk and/or other storage medium that is or becomes know or practicable. In some embodiments, the third data storage device 840c may comprise a USB keyfob, dongle, and/or other type of flash memory data storage device that is or becomes know or practicable. In some embodiments, the fourth data storage device 840d may comprise RAM of any type, quantity, and/or configuration that is or becomes practicable and/or desirable. In some embodiments, the fourth data storage device 840d may comprise an off-chip cache such as a Level 2 (L2) cache memory device. According to some embodiments, the fifth data storage device 840e may comprise an on-chip memory device such as a Level 1 (L1) cache memory device.

The data storage devices 840a-e depicted in FIG. 8A, FIG. 8B, FIG. 8C, FIG. 8D, and FIG. 8E are representative of a class and/or subset of computer-readable media that are defined herein as “computer-readable memory” (e.g., non-transitory memory devices as opposed to transmission devices or media). The data storage devices 640a-e may generally store program instructions, algorithms, software engines, code, and/or modules that, when executed by a processing device cause a particular machine to function in accordance with one or more embodiments described herein.

V. Rules of Interpretation

Throughout the description herein and unless otherwise specified, the following terms may include and/or encompass the example meanings provided. These terms and illustrative example meanings are provided to clarify the language selected to describe embodiments both in the specification and in the appended claims, and accordingly, are not intended to be generally limiting. While not generally limiting and while not limiting for all described embodiments, in some embodiments, the terms are specifically limited to the example definitions and/or examples provided. Other terms are defined throughout the present description.

Neither the Title (set forth at the beginning of the first page of this patent application) nor the Abstract (set forth at the end of this patent application) is to be taken as limiting in any way as the scope of the disclosed invention(s). Headings of sections provided in this patent application are for convenience only, and are not to be taken as limiting the disclosure in any way.

All definitions, as defined and used herein, should be understood to control over dictionary definitions, definitions in documents incorporated by reference, and/or ordinary meanings of the defined terms. The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

The indefinite articles “a” and “an,” as used herein in the specification and in the claims, unless clearly indicated to the contrary, should be understood to mean “at least one” or “one or more”.

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a FDA” does not imply that any or all of the three items of that list are mutually exclusive and does not imply that any or all of the three items of that list are comprehensive of any category.

Some embodiments described herein are associated with a “user device” or a “network device”. As used herein, the terms “user device” and “network device” may be used interchangeably and may generally refer to any device that can communicate via a network. Examples of user or network devices include a PC, a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device. Users may comprise, for example, customers, consumers, product underwriters, product distributors, customer service representatives, agents, brokers, etc.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

As utilized herein, the terms “program” or “computer program” may refer to one or more algorithms formatted for execution by a computer. The term “module” or “software module” refers to any number of algorithms and/or programs that are written to achieve a particular output and/or output goal—e.g., a ‘login credentialing’ module (or program) may provide functionality for permitting a user to login to a computer software and/or hardware resource and/or a ‘shipping’ module (or program) may be programmed to electronically initiate a shipment of an object via a known and/or available shipping company and/or service (e.g., FedEX®). The terms “engine” or “software engine” refer to any combination of software modules and/or algorithms that operate upon one or more inputs to define one or more outputs in an ongoing, cyclical, repetitive, and/or loop fashion. Data transformation scripts and/or algorithms that query data from a data source, transform the data, and load the transformed data into a target data repository may be termed ‘data transformation engines’, for example, as they repetitively operate in an iterative manner upon each row of data to produce the desired results.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™ TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

It will be understood that various modifications can be made to the embodiments of the present disclosure herein without departing from the scope thereof. Therefore, the above description should not be construed as limiting the disclosure, but merely as embodiments thereof. Those skilled in the art will envision other modifications within the scope of the invention as defined by the claims appended hereto.

What is claimed is:

1. A system for autonomous drone-based solar panel maintenance, comprising:
an electronic processing device;
a sensor device in communication with the electronic processing device;
a location device in communication with the electronic processing device;
a propulsion device in communication with the electronic processing device; and
a non-transitory data storage device in communication with the electronic processing device, the non-transitory data storage device storing solar panel maintenance data and instructions that when executed by the electronic processing device, result in:
identifying, based on astrological data, a navigational route that crosses between the sun and a target solar panel;
maneuvering, by selectively activating the propulsion device, the sensor along the navigational route and to a location proximate to the solar panel;
acquiring, by the sensor device, data descriptive of the location;
identifying, by comparing the data descriptive of the location to predefined solar panel data, at least one solar panel;
identifying, by comparing a subset of the data descriptive of the location that corresponds to the at least one solar panel to the predefined solar panel data, at least one solar panel feature;
measuring, by selectively activating the sensor device, at least one solar panel feature;
computing, based on the measurement of the at least one solar panel feature and a current location identified by the location device, an orientation of the at least one solar panel.

2. The system for autonomous drone-based solar panel maintenance of claim 1, wherein the at least one solar panel feature comprises a reflection of the sun.

3. The system for autonomous drone-based solar panel maintenance of claim 1, wherein the at least one solar panel feature comprises a reflection of the moon.

4. The system for autonomous drone-based solar panel maintenance of claim 1, wherein the identifying of the at least one solar panel feature comprises matching the subset of the data descriptive of the location that corresponds to the at least one solar panel to the predefined solar panel data and wherein the predefined solar panel data comprises a shape file descriptive of a shape of a shadow.

5. The system for autonomous drone-based solar panel maintenance of claim 1, wherein the measuring of the at least one solar panel feature comprises measuring an angle of the at least one solar panel feature with respect to a datum.

6. The system for autonomous drone-based solar panel maintenance of claim 1, wherein the instructions, when executed by the electronic processing device, further result in:
measuring, by selectively activating the sensor device, a level of reflection of the at least one solar panel.
